(19) United States
(12) Patent Application Publication
(10) Pub. No.: US 2010/0016017 A1
(43) Pub. Date: Jan. 21, 2010

(54) POWER SAVING MOBILE PHONE AND METHOD THEREOF

(75) Inventors: XIAO-GUANG LI, Shenzhen City (CN); HAN-CHE WANG, Tu-Cheng (TW); RUEY-SHYANG YOU, Tu-Cheng (TW); SHIH-TSAI LIU, Tu-Cheng (TW); HUA-DONG CHENG, Shenzhen City (CN); KUAN-HONG HSIEH, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (Shenzhen) CO., LTD, Shenzhen (CN); HON HAI PRECISION INDUSTRY CO., LTD., Tu-Cheng (TW)

(21) Appl. No.: 12/425,390

(22) Filed: Apr. 17, 2009

(30) Foreign Application Priority Data
Jul. 18, 2008 (CN) 200810302791.8

(51) Int. Cl. H04B 1/40; H04M 1/00

(52) U.S. Cl. 455/556.1; 455/574

(57) ABSTRACT

The present invention provides a power saving mobile phone and a power saving method adapted for the mobile phone. The mobile phone includes a media playing controller for controlling media playing functions and a mobile communications controller for controlling mobile communications functions. The method includes: a) receiving an incoming call when playing an audio file; b) pausing playing the audio file; c) receiving an answer call instruction of the incoming call; d) measuring time; e) judging whether a hang-up instruction is received in a predetermined time period based on measured time; and f) stopping playing the audio file and decreases a voltage of the media playing controller to zero, if the hang-up instruction is not received in the predetermined time period.

### BACKGROUND

1. Technical Field

The disclosure relates to mobile phones and, more particularly, to a power saving mobile phone and a power saving method adapted for the mobile phone.

2. Description of the Related Art

Mobile phone power consumption is an important issue. Users often use more than one function at a time on their phone, for example, leaving an MP3 player of the phone on while making a call. Therefore, a battery charge often does not last long. Accordingly, what is needed in the art is a power saving mobile phone and a power saving method that overcomes the aforementioned deficiencies.

### BRIEF DESCRIPTION OF THE DRAWINGS

The components in the drawings are not necessarily drawn to scale, the emphasis instead being placed upon clearly illustrating the principles of the mobile phone. Moreover, in the drawings, like reference numerals designate corresponding parts throughout the several views.

FIG. 1 is a block diagram of a hardware infrastructure of a mobile phone in accordance with an exemplary embodiment.

FIG. 2 is a voltage variation diagram of controllers of the mobile phone of FIG. 1.

FIG. 3 is a flowchart of a power saving method implemented by the mobile phone of FIG. 1.

### DETAILED DESCRIPTION

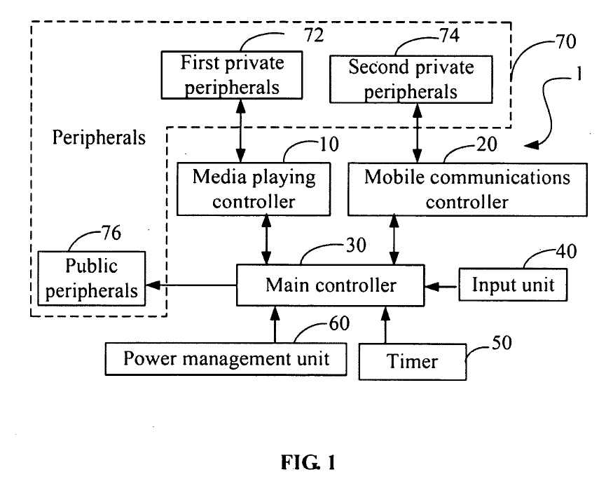

FIG. 1 is a block diagram of a hardware infrastructure of a mobile phone in accordance with an exemplary embodiment. The mobile phone 1 includes a media playing controller 10, a mobile communications controller 20, a main controller 30, an input unit 40, a timer 50, a power management unit 60, and a set of peripherals 70. The media playing controller 10 is configured for controlling media playing functions. The mobile communications controller 20 is configured for controlling mobile communications functions, such as processing an incoming call from an external wireless communications system (not shown). The media playing controller 10 and the mobile communications controller 20, connected to the main controller 30, both receive control signals from the main controller 30.

The media playing controller 10 may be a moving picture experts group audio layer3 (MP3) controller, a moving picture experts group audio layer 4 (MP4) controller, and the like. The mobile communications controller 20 may be a global system for mobile communications (GSM) controller, a general packet radio service (GPRS) controller, a code division multiple access (CDMA) controller, and the like.

The main controller 30 is configured for switching between the functions of the media playing controller 10 and the mobile communications controller 20 according to instructions from the input unit 40. The main controller 30 includes a plurality of switch circuits (not shown). The input unit 40 is configured for generating instructions in response to user input, for example, an answer call instruction, a hang-up instruction, and the like.

When the input unit 40 generates a playing instruction, the media playing controller 10 plays an audio file, and the mobile communications controller 20 is on standby. When the media playing controller 10 is playing the audio file and the mobile communications controller 20 receives an the incoming call from the external wireless communications system, the main controller 30 switches the mobile communications controller 20 to control the set of peripherals 70 and the media playing controller 10 pauses playing the audio file. The timer 50 is configured for measuring time when the mobile communications controller 20 receives the incoming call or the input unit 40 generates an answer call instruction of the incoming call. The power management unit 60 is configured for managing power voltages of the media playing controller 10 and the mobile communications controller 20 of the mobile phone 1.

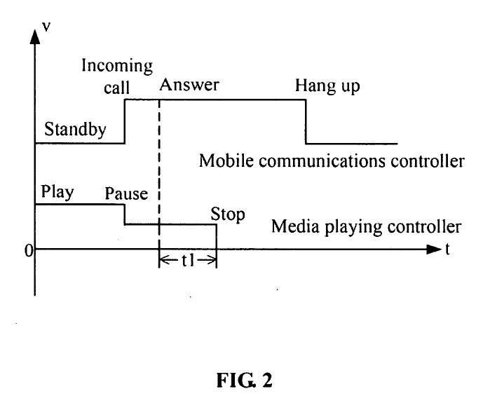

FIG. 2 is a voltage variation diagram of controllers of the mobile phone of FIG. 1. When the mobile phone 1 receives the answer call instruction and the media playing controller 10 pauses playing the audio file, the timer 50 starts measuring time. The main controller 30 judges whether the input unit 40 generates a hang-up instruction in a predetermined time period t1, for example, 60 seconds. If the mobile phone 1 receives the hang-up instruction in the predetermined time period t1, the media playing controller 10 resumes playing the audio file. If the mobile phone 1 doesn't receive the hang-up instruction in the predetermined time period t1, the media playing controller 10 stops playing the audio file, and the power management unit 60 decreases the voltage of the media playing controller 10 to zero.

The set of peripherals 70 include first private peripherals 72, second private peripherals 74, and public peripherals 76. The first private peripherals 72, connected to the media playing controller 10, are configured for receiving control signals from the media playing controller 10. The second private peripherals 74, connected to the mobile communications controller 20, are configured for receiving control signals from the mobile communications controller 20. The public peripherals 76, connected to the main controller 30, are configured for receiving control signals from the main controller 30. For example, when the main controller 30 switches from the functions of the media playing controller 10 to the functions of the mobile communications controller 20, the mobile communications controller 20 controls the public peripherals 76. In another exemplary embodiment, the first private peripherals 72, the second private peripherals 74, and the public peripherals 76 may be all connected to the main controller 30 and all receive control signals from the main controller 30.

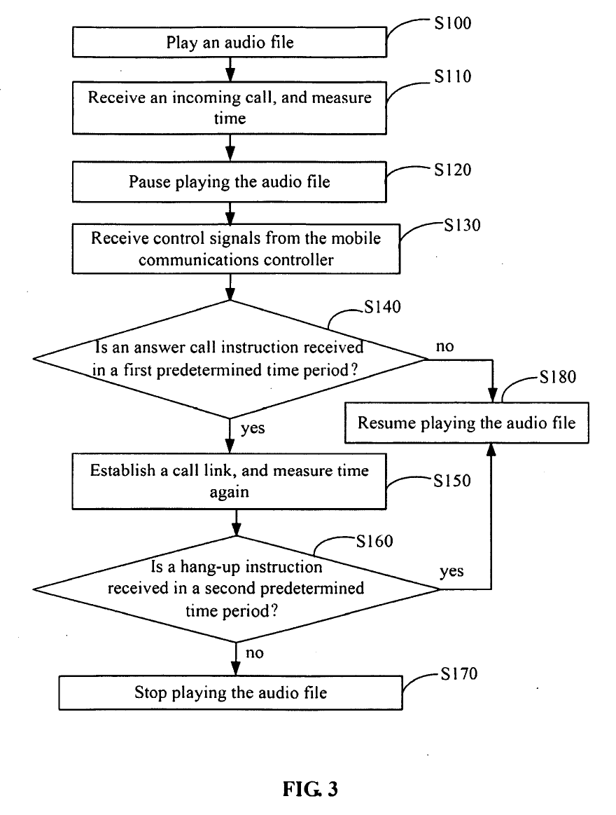

FIG. 3 is a flowchart of a power saving method implemented by the mobile phone of FIG. 1. In step S100, the mobile communications controller 20 is on standby, and the media playing controller 10 is playing the audio file. In step S110, the mobile communications controller 20 receives an incoming call from the external wireless communications system, and the timer 50 measures time. In step S120, the media playing controller 10 pauses playing the audio file, and the power management unit 60 decreases the voltage of the media playing controller 10. In step S130, the public peripherals 76 receive the control signals from the mobile communications controller 20, that is, the mobile communications controller 20 controls the public peripherals 76 to display an incoming call interface and output a ring tone.

In step S140, the main controller 30 judges whether the answer call instruction is received from the input unit 40 in a first predetermined time period. If the answer call instruction is not received in the first predetermined time period, in step S180, the media playing controller 10 resumes playing the audio file. If the answer call instruction is received in the first predetermined time period, in step S150, the mobile communications controller 20 establishes the call link, and the timer 50 starts measuring time again.

In step S160, the main controller 30 judges whether the hang-up instruction is received from the input unit 40 in the second predetermined time period t1. If the hang-up instruction is received in the second predetermined time period t1, the procedure returns to step S180. If the hang-up instruction is not received in the second predetermined time period t1, in step S170, the media playing controller 10 stops playing the audio file, and the power management unit 60 decreases the voltage of the media playing controller 10 to zero.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A mobile phone comprising:
an input unit configured for generating instructions in response to user input;
a media playing controller configured for controlling media playing functions;
a mobile communications controller configured for controlling mobile communications functions;
a timer configured for measuring time when the media playing controller is playing an audio file, and an answer call instruction of an incoming call from the input unit is received;
a power management unit configured for managing power voltages of the media playing controller and the mobile communications controller; and
a main controller configured for switching between the functions of the media playing controller and the mobile communications controller, and judging whether a hang-up instruction of the incoming call from the input unit is received in a predetermined time period when the media playing controller pauses playing the audio file;
wherein when the hang-up instruction is not received in the predetermined time period, the media playing controller stops playing the audio file and the power management unit decreases the voltage of the media playing controller to zero.

2. The mobile phone as recited in claim 1, wherein when the hang-up instruction is received in the predetermined time period, the media playing controller resumes playing the audio file.

3. The mobile phone as recited in claim 1, wherein the timer is further configured for measuring time when the mobile communication controller receives the incoming call.

4. The mobile phone as recited in claim 3, wherein the main controller is further configured for judging whether the answer call instruction is received in a second predetermined time period.

5. The mobile phone as recited in claim 4, wherein if the answer call instruction is not received in the second predetermined time period, the media playing controller resumes playing the audio file.

6. The mobile phone as recited in claim 4, wherein if the answer call instruction is received in the second predetermined time period, the timer start measuring time again.

7. A power saving method of a mobile phone, the mobile phone including a media playing controller for controlling media playing functions and a mobile communications controller for controlling mobile communications functions, the method comprising:
receiving an incoming call when playing a media file;
pausing playing the media file;
receiving an answer call instruction of the incoming call;
measuring time;
judging whether a hang-up instruction is received in a predetermined time period based on measured time; and
stopping playing the audio file and decreases a voltage of the media playing controller to zero, if the hang-up instruction is not received in the predetermined time period.

8. The method as recited in claim 7, further comprising:
resuming playing the audio file, if the hang-up instruction is received in the predetermined time period.

9. The method as recited in claim 7, further comprising:
measuring time, when receiving the incoming call.

10. The method as recited in claim 9, further comprising:
judging whether the answer call instruction is received in a second predetermined time period based on measured time.

11. The method as recited in claim 10, further comprising:
resuming playing the audio file, if the answer call instruction is not received in the second predetermined time period.

12. The method as recited in claim 10, further comprising:
starting measuring time again, if the answer call instruction is received in the second predetermined time period.
